(19) United States
(12) Patent Application Publication
(10) Pub. No.: US 2007/0132781 A1
(43) Pub. Date: Jun. 14, 2007

(54) Information processing apparatus and control method thereof

(75) Inventors: Masaya Kato, Ome-shi (JP); Mitsuru Shimbayashi, Mitaka-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/634,948

(22) Filed: Dec. 7, 2006

(30) Foreign Application Priority Data
Dec. 8, 2005 (JP) 2005-354929

(51) Int. Cl. G09G 5/00

(52) U.S. Cl. 345/619

(57) ABSTRACT

A recording title is separated into arbitrary chapters, the chapters are associated with blocks and located in an association area, desired blocks are relocated in a coupling and editing area, the chapters associated with the relocated blocks are edited as a new title in accordance with the location of the blocks.

### CROSS-REFERENCE TO RELATED APPLICATIONS

This application is based upon and claims the benefit of priority from Japanese Patent Application No. 2005-354929, filed Dec. 8, 2005, the entire contents of which are incorporated herein by reference.

### BACKGROUND

1. Field

This invention relates to an editing apparatus of moving image data, etc. and, more particularly, to an information processing apparatus capable of easily editing moving images by associating the moving image data with a physical unit and changing a location of the unit and to a control method of the information processing apparatus.

2. Description of the Related Art

When image data such as moving image data are edited, imaginary objects are first formed on software and arbitrary image data are associated with the objects, as disclosed in, for example, Jpn. Pat. Appln. KOKAI Publication No. 8-65613. Then, the associated image data are edited by changing locations of the objects (Jpn. Pat. Appln. KOKAI Publication No. 8-65613).

According to this technique, however, since the processing is conducted with the imaginary software, it cannot easily be understood intuitively.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing a configuration of a notebook PC equipped with an information processing apparatus according to a first embodiment of the present invention;

FIG. 2 is a block diagram showing the configuration of the notebook PC;

FIG. 3 is an illustration of a processing of editing image data; and

FIG. 4 is a flowchart of a control method of the information processing apparatus according to the first embodiment of the present invention.

### DETAILED DESCRIPTION

Various embodiments according to the invention will be described hereinafter with reference to the accompanying drawings. In general, according to one embodiment of the invention, an information processing apparatus, editing and displaying image data recorded in a record medium. The apparatus comprises first area means for locating a plurality of units, second area means for relocating the plurality of units, locating means for separating the image data into arbitrary chapters, associating a desired chapter with the plurality of units, and locating the plurality of units in the first area means, relocating means for relocating the plurality of units located by the location means in the second area means in a desired order, and editing means for editing the image data which are the chapters associated with the plurality of units relocated by the relocating means, in accordance with the location of the plurality of relocated units.

An embodiment of the present invention will be explained below with reference to the accompanying drawings.

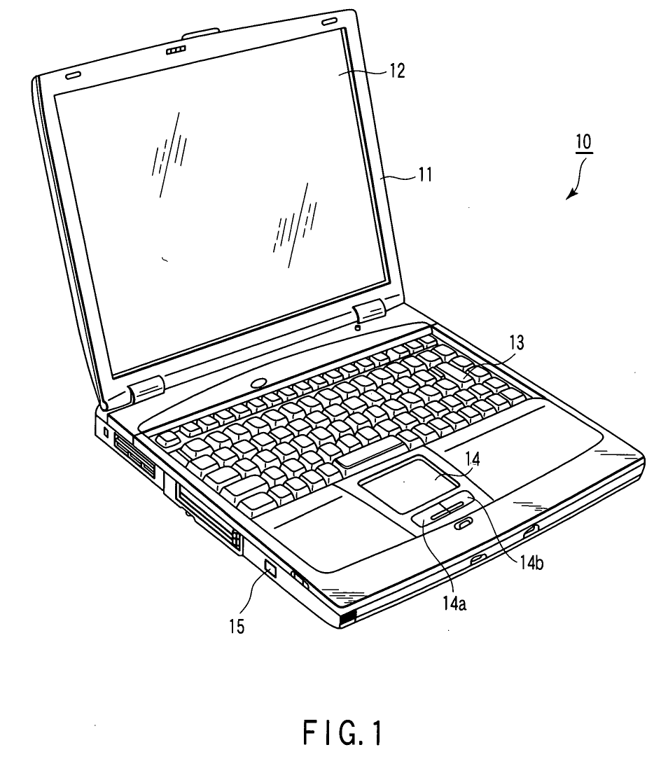

FIG. 1 shows a system configuration of an information processing apparatus according to an embodiment of the present invention.

The information processing apparatus is implemented as a battery-powered notebook computer 10.

The computer 10 is composed of a computer body and a display unit 11 as shown in FIG. 1. A display device composed of an LCD (Liquid Crystal Display) is embedded in the display unit 11. A display screen 12 is located approximately at the center of the display unit 11.

The display unit 11 is attached to the computer 10 so as to freely pivot between an opened position and a closed position. The main body of the computer 10 has a housing shaped in a thin box, and comprises a keyboard 13 on a top face, a touch pad 14 and two buttons 14a, 14b on a palm rest, an optical drive unit 15 on a side face, etc.

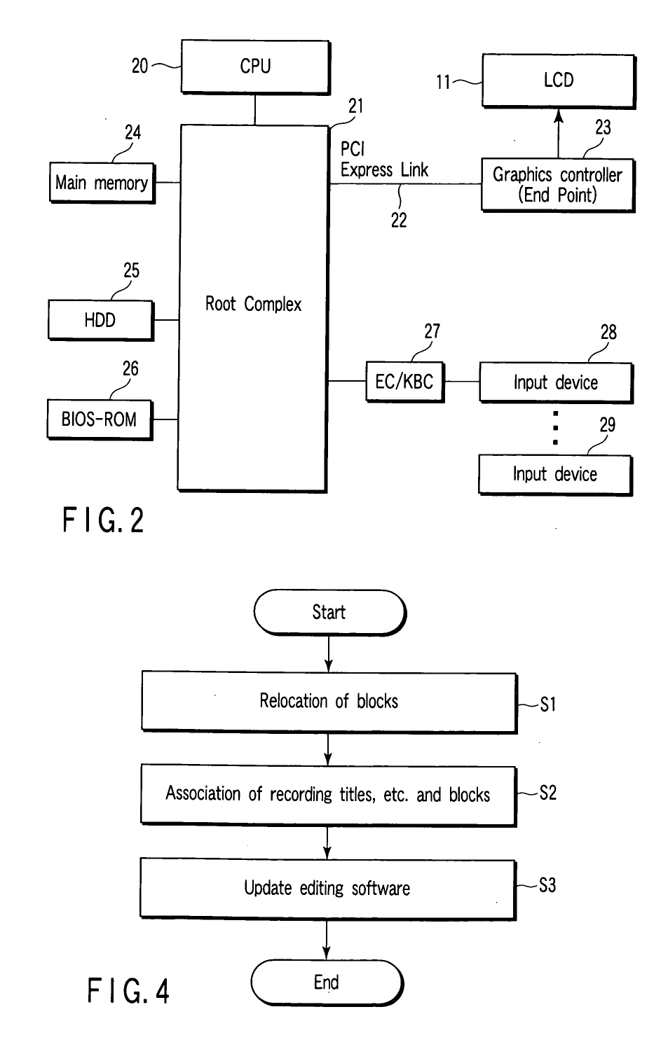

FIG. 2 is a block diagram showing the configuration of the computer 10.

The computer 10 comprises a CPU (Central Processing Unit) 20, a Root Complex 21, a main memory 24, a graphics controller (End Point) 23, a PCI Express Link 22 making a connection between the Root Complex 21 and the graphics controller 23, the display unit 11, an embedded controller/keyboard controller IC (EC/KBC) 27, a hard disk drive (HDD) 25, a BIOS-ROM 26, input devices 28, 29 connected to the EC/KBC 27, etc.

The Root Complex 21, the graphics controller 23, etc. are devices in conformity with the PCI EXPRESS standards. The communications between the Root Complex 21 and the graphics controller 23 are executed over the PCI Express Link 22 located between the Root Complex 21 and the graphics controller 23.

The CPU 20 is a processor controlling the operations of the computer, executing various kinds of programs (operating system and application systems) loaded on the main memory 24 by the HDD 25. In addition, the CPU 20 also executes the BIOS (Basic Input Output System) stored in the BIOS-ROM 26. The BIOS is a program for controlling the hardware.

The Root Complex 21 is a bridge device making a connection between a local bus of the CPU 20 and the graphics controller 23. In addition, the Root Complex 21 also has a function of executing the communications with the graphics controller 23 over the PCI Express Link 22.

The graphics controller 23 is a display controller which controls the display unit 11 employed as a display monitor of the computer.

The EC/KBC 27 is a one-chip microcomputer on which an embedded controller for power management and a keyboard controller controlling the keyboard (KB) 13 and the touch pad 14 are integrated. The EC/KBC 27 has a function of controlling power-on/power-off of the computer 10, in cooperation with a power supply controller, in response to the user's operation of the power button.

Next, a method of controlling the information processing apparatus having the above-described configuration is described.

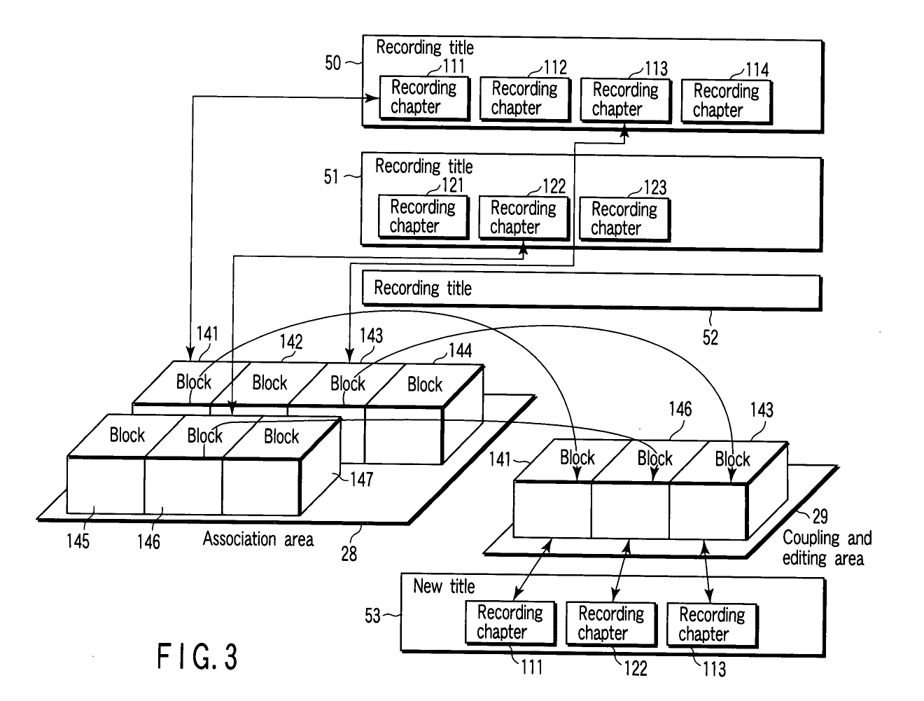

FIG. 3 is an illustration showing block units used to edit the image data such as recording data (moving image data) of broadcast waves, etc., and the input devices 28, 29.

FIG. 4 is a flowchart of the control method. In the present application, “image data” include moving image data.

As shown in FIG. 3, the input devices 28, 29 are readers connected to the computer 10 via an interface such as a USB cable. On the input devices, for example, units (physical stubs) such as blocks, comprising ID information such as barcodes are located.

Recording titles 50, 51 recorded in the computer 10 are split in chapters 111 to 114 and 121 to 123 by moving image editing software, etc.

First, as shown in FIG. 4, location of blocks is read in an association area, which is input device (first area means) 28 (step S1). As shown in FIG. 3, for example, blocks 141, 142, 143, 144 are aligned, and blocks 145, 146, 147 are aligned beside the blocks 141, 142, 143, 144. This location is read.

The image data and the block units are associated by the CPU 20 of the computer 10 (step S2). For example, the recording chapter 111 of the recording title 50 is associated with the block 141. The recording chapter 113 of the recording title 50 is associated with the block 143. The recording chapter 122 of the recording title 51 is associated with the block 146.

Next, the associated blocks are relocated in a coupling and editing area, which is the input device (second area means) 29. For example, the blocks 141, 146, 143 is aligned in order and relocated.

The moving image editing software relocates as a new title 53 the chapters 111,122, 113 associated with the blocks 141, 146, 143, respectively, in order of the block location and updates the location of the chapters of the mobbing image file (step S3). This editing and updating operation may be automatically conducted or may be set at an arbitrary timing.

The block ID information is not limited if it has ID information of the IC tag, etc. other than the barcode. In addition, a liquid crystal display unit may be provided in each of the blocks to display the block name, the associated chapter name, or a part of the moving image of the chapter, etc.

Furthermore, association of the chapters in the recording title has been explained in the above embodiment. However, the entire body of the recording title such as the recording title 52 may be associated with a desired block as shown in, for example, FIG. 3. The example using two input devices (two areas) has been explained in the above embodiment, but three or more input devices may be used.

A plurality of blocks may be classified as one group, initially irrespective of the order. In this case, they can be classified in a third input device, etc. other than the two input devices. A plurality of classified blocks may be aligned later.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, editing and displaying image data recorded in a record medium, comprising:
first area means for locating a plurality of units;
second area means for relocating the plurality of units;
locating means for separating the image data into arbitrary chapters, associating a desired chapter with the plurality of units, and locating the plurality of units in the first area means;
relocating means for relocating the plurality of units located by the location means in the second area means in a desired order; and
editing means for editing the image data which are the chapters associated with the plurality of units relocated by the relocating means, in accordance with the location of the plurality of relocated units.

2. The apparatus according to claim 1, wherein each of the plurality of units comprises identification information, and the identification information is read to discriminate the location of the plurality of units.

3. The apparatus according to claim 1, wherein each of the plurality of units comprises information display means and allows the information display means to display a part of the associated image data.

4. The apparatus according to claim 1, wherein a plurality of predetermined units, of the plurality of units, are classified as one group.

5. The apparatus according to claim 1, wherein the editing means is started at an arbitrary timing.

6. An information processing apparatus, editing and displaying image data recorded in a record medium, comprising:
first area means for locating a plurality of units;
second area means for relocating the plurality of units;
locating means for associating the image data with the plurality of units and locating the plurality of units in the first area means;
relocating means for relocating the plurality of image data items located by the location means in the second area means in a desired order; and
editing means for editing the image data items associated with the plurality of units relocated by the relocating means, in accordance with the location of the plurality of relocated units.

7. A method of controlling an information processing apparatus editing and displaying image data recorded in a record medium, comprising:
separating the image data into arbitrary chapters, associating a desired chapter with a plurality of units, and locating the plurality of units in a first area means;
relocating the plurality of units located by the location means in a second area means in a desired order; and
editing the image data which are the chapters associated with the plurality of units relocated by the relocating means, in accordance with the location of the plurality of relocated units.

8. A method of controlling an information processing apparatus editing and displaying image data recorded in a record medium, comprising:
associating the image data with a plurality of units and locating the plurality of units in a first area means;
relocating the plurality of units located by the location in a second area means in a desired order; and
editing the image data associated with the plurality of units relocated by the relocation, in accordance with the location of the plurality of relocated units.

9. The method according to claim 7, wherein each of the plurality of units comprises identification information, and the identification information is read to discriminate the location of the plurality of units.

10. A program employed in an information processing apparatus editing and displaying image data recorded in a record medium, the program allowing a computer:
to separate the image data into arbitrary chapters, associate a desired chapter with a plurality of units, and locate the plurality of units in a first area means;
to relocating means for relocating the plurality of units located by the location means in a second area means in a desired order; and
to edit the image data which are the chapters associated with the plurality of units relocated by the relocating means, in accordance with the location of the plurality of relocated units.

11. A program employed in an information processing apparatus editing and displaying image data recorded in a record medium, the program allowing a computer:
to associate the image data with a plurality of units and locate the plurality of units in a first area means;
to relocate the plurality of units located by the location in a second area means in a desired order; and
to edit the image data associated with the plurality of units relocated by the relocation, in accordance with the location of the plurality of relocated units.
